(19) United States
(12) Patent Application Publication
(10) Pub. No.: US 2002/0111790 A1
(43) Pub. Date: Aug. 15, 2002

(54) Universal computer controlled display terminal adapted to receive withdrawable user cards with stored user data for personalizing interactive graphic display interface

(75) Inventors: Gerald Francis McBrearty, Austin, TX (US); Shawn P. Mullen, (US); Johnny M. Shieh, (US)

Correspondence Address: International Business Machines Corporation, Intellectual Property Law Department, Internal Zip 4054, 11400 Burnet Road, Austin, TX, 78758, US

(73) Assignee: International Business Machines Corporation

(21) Appl. No.: 09/726,292

(22) Filed: Feb. 12, 2001

(51) Int. Cl. G06F 17/28

(52) U.S. Cl. 704/7

(57) ABSTRACT

A universal computer controlled display terminal provided with a withdrawable card with stored data specific to the user of said card and a process responsive to the stored data for displaying on said terminal a layout of user interactive graphics personalized to said user. The invention is very effective in display terminals including a user interactive input touch screen having said layout of graphics personalized to said user. The layout of graphics may include a set of enlarged touch pads. The layout may also include images personalized to said user. The user card may also include integrated circuitry associated with said stored data, e.g. a smartcard. The data displayed responsive to the data stored on the card may also include text personalized to the user. The text may be in a language personalized to said user, or the text may be in an enlarged character font.

### TECHNICAL FIELD

The present invention relates to user interactive computer supported display technology and particularly to universal user interactive display terminals which are activated by withdrawable user cards such as ATM cards or smartcards.

### BACKGROUND OF RELATED ART

In recent years, convergence of the data processing industry with the consumer electronics and communications industries has accelerated extensive consumer and business involvement in computer driven technologies. As a result of these changes, all aspects of work in business and technology requires human/computer interfaces. There is a need to make computer directed activities accessible to a substantial portion of people who, up to a few years ago, were computer illiterate or, at best, computer indifferent. In order for the extensive computer supported market places to continue and be commercially productive, it will be necessary for a large segment of computer indifferent workers and consumers to be involved in computer interfaces. Thus, the challenge of technology is to create display interfaces to such computers which are as close as possible to the to the real world of the user.

In the case of the users' own personal desktop, laptop and handheld computers, operating systems try to provide the user with facilities for customizing interfaces to the users' own specific needs and preferences. On the other hand, there is a rising number of universal computer controlled display terminals available for a wide variety of financial, marketing, voting and information purposes which can be activated by insertable and withdrawable personal user cards. Originally such cards were primarily used for banking, i.e. ATM (Automatic Teller Machine) cards. Such ATM cards contain stored data personal to the user, e.g. at least a user ID. They may be much more elaborate, e.g. smartcards which have a limited amount of “intelligence” or logic in addition to memory. The user card activatable display terminals include electronic kiosks marketing a variety of goods or dispensing information as in airports or railroad stations. Also, display terminals are being increasingly used for public and business purposes.

While such universal display terminals may be controlled through external buttons or pointing devices, the prevalent number of such terminals are touch screen terminals. Such terminals are easy to use because they allow the user to point directly to the display screen with his finger, a pen or a stylus to make selections. The touch panel has been in use in various forms for several years. Several different technologies have been involved in touch panels. Original touch panels used a series of infrared LEDs and light sensors, such as photodiodes, to provide low resolution panels of up to 50 resolvable positions. The LEDs and sensors form a grid of invisible light beams which the finger breaks to, thus, indicate its position. The capacitatively coupled touch panels were able to develop a resolution of about 100 resolvable positions. Higher resolution touch screens have been developed using a variety of technologies from sound waves reflected off fingers to conductive/resistive layers separated by insulative material broken down by touch.

Because such display terminals are universal, they have conventionally had their display interfaces designed for general usage. Such general interfaces, of course, fail to take the individual needs of users into account.

### SUMMARY OF THE PRESENT INVENTION

The present invention provides a solution to the above-mentioned shortcomings of universal computer controlled display terminals by providing the withdrawable card with stored data specific to the user of said card; and means responsive to said stored data for displaying on said terminal a layout of user interactive graphics personalized to said user. The invention is very effective in display terminals including a user interactive input touch screen having said layout of graphics personalized to said user. The layout of graphics may include a set of enlarged touch pads. The layout may also include images personalized to said user. The user card may also include integrated circuitry associated with said stored data, e.g. a smartcard. The data displayed responsive to the data stored on the card may also include text personalized to the user. The text may be in a language personalized to said user, e.g. the text may be in an enlarged character font.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit, a primary display with a touch screen which is capable of implementing the present invention;

FIG. 2 is a diagrammatic view of a standard default universal terminal display screen;

FIG. 3 is a display screen like that of FIG. 2 but only with images personalized to a specific user;

FIGS. 4 and 5 are diagrammatic views of screens conveying information like that of the information conveyed by the display screen of FIG. 2 but with enlarged text and selection pads personalized for a user with sight limitations; and

FIG. 6 is a flowchart of an illustrative process implementing the present invention.

### DETAILED DESCRIPTION OF THE PREFERRED EMBODIMENT

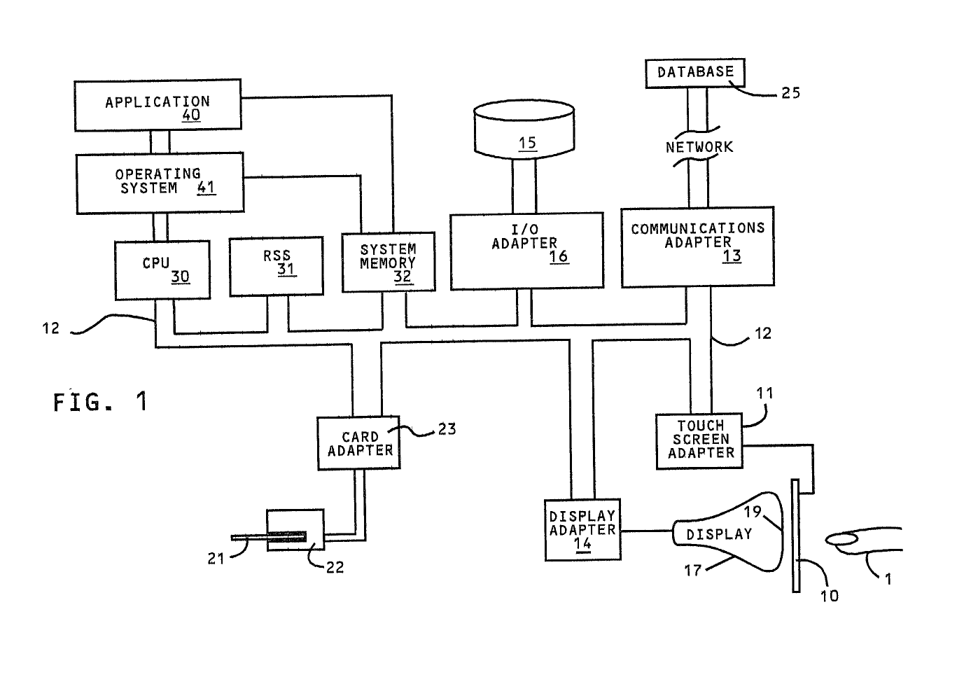

Referring to FIG. 1, a data processing system is shown which may function as the computer controlled display terminal with interactive touch screen. A conventional central processing unit (CPU) 30 such as one of the microprocessors available from Intel Corporation or AMD Inc. is provided and interconnected to various other components by system bus 12. An operating system 41 runs on CPU 30 and provides control and is used to coordinate the functions of the various components of FIG. 1. Operating system 41 may be one of the commercially available operating systems such as the Microsoft Windows95™ or the OS/2™ operating system available from International Business Machines Corporation (IBM). These, of course, may be modified to eliminate elements not needed by the universal terminals such as ATMs or vending kiosks. A programming application for operating the present invention, application 40, to be subsequently described in detail, runs in conjunction with operating system 41 and provides output calls to the operating system 41 which implement the various functions to be performed by the application 40. A Read Only Storage (ROS) memory 31 is connected to CPU 30 via bus 12 and includes the Basic Input/Output System (BIOS) that controls the basic computer functions. Random Access Memory (RAM) system 32, I/O adapter 16 and communications adapter 13 are also interconnected to system bus 12. It should be noted that software components, including the operating system 41 and the application 40, are loaded into memory system 32 which is the computer system's main memory. I/O adapter 16 conventionally communicates with the disk storage device 15, i.e. a hard drive. Communications adapter 34 interconnects bus 12 with outside networks, such as the Internet, to enabling the data processing system to communicate with other such systems, particularly databases 25 from which data specific to the user of the inserted card may be obtained. The withdrawable user card 21 is inserted into card reader 22 which is connected via card adapter 23 and bus 12. The user data from the card is stored in the system memory along with any data specific to the user which is obtained from database 25. Any conventional touch screen display may be used. Typically, FIG. 1, there is a display 17 having surface 19 upon which the visual output from the computer is generated via display adapter 14. A touch sensitive display screen or panel 10 is superimposed upon display surface 19. This touch screen, which is about ¼″ to ½″ from surface 19, is responsive to a touch stimulus, e.g. finger 18, applied by the user to issue commands to the computer system. The touch screen 10 resolution is determined by digitizing circuitry (not shown) in a pointing device adapter 11 to form a two-dimensional array of discrete coordinate points. A touch stimulus applied to any of the coordinate points is detected by a sensor array (not shown) in the touch screen 10. The sensor array generates an analog signal responsive to the force imparted to the touch screen. This signal is digitized by a sampling A to D convertor circuit (not shown) in touch screen 10 to produce an input data value. This data value, together with the coordinates to which it relates, are transmitted from touch screen 10 to touch screen adapter 11. The input data value corresponding to each set of coordinates is conventionally refreshed by the A to D converter circuit about 60 times a second. The pointing device adapter 11 connected to the bus architecture 12 passes each set of coordinates and the corresponding input data value to the bus architecture 12.

The touch panels or screens 10 may use any of the standard technologies. One current conventional technology uses higher resolution panels with resistive/conductive composites. Such structures use two slightly separated layers of transparent material, one coated with a thin layer of conductive material and the other with resistive material. The pressure of the fingertip forces the layers to touch and the voltage drop across the resistive substrate is measured and used to determine the coordinates of the touched positions. There are many such conductive/resistive touch screen displays on the market which may be used in the implementation of the present invention such as the IBM 2489 Model 600 and PGI Super Nightingale.

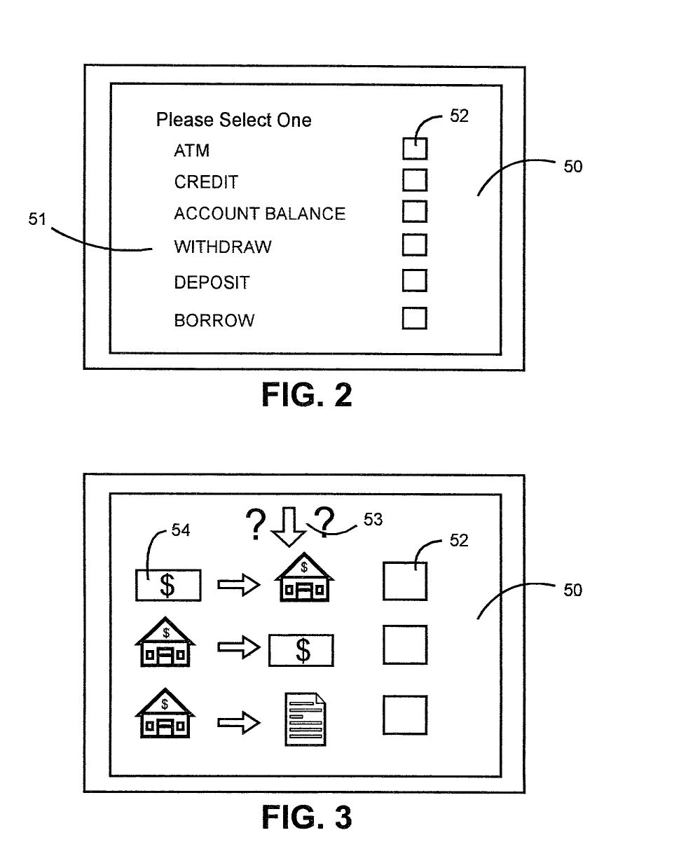

There will now be described a simple illustration of the present invention with respect to the display screens of FIGS. 2 through 5. When the screen images are described, it will be understood that these may be rendered by storing image and text creation programs such as those in any conventional window operating system in the memory 32 of the system of FIG. 1. Display screen images are presented to the viewer on-screen 19 of display monitor 17 of FIG. 1. In accordance with the standard touch screen techniques described above, the user may control the screen interactively through finger 18 touching touch screen 10 which operates through pointing device adapter 11 and bus 12 to call upon the routines in application program 40 which is loaded in system RAM 32 cooperating with the operating system 41 to create the images display adapter 14 to control the display screen 19 on display monitor 38.

The withdrawable cards 21 used in the present invention may have any conventional structure used in personalized cards for universal computer controlled display terminals. The cards may have only a simple magnetic memory strip with just user ID data, in which case any further personalized user data may be obtained by the terminal system from a database, such as database 25 in FIG. 1. The card may have optical data storage, in which case reader 22 would be an optical reader.

The card may also be a smartcard, i.e. it contains integrated circuitry with a limited amount of intelligence through logic. The smartcard, and related smart media, is described in detail at pages 388-389 of the text, Winn L Rosch Hardware Bible, 5th Edition, 1999, Que Division of MacMillan Publishing, Indianapolis, Ind.

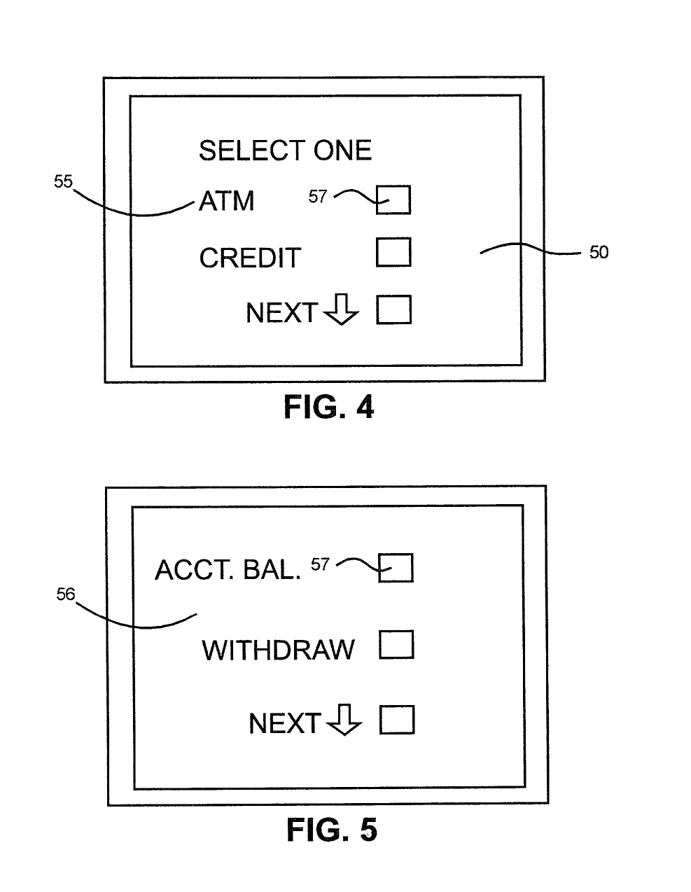

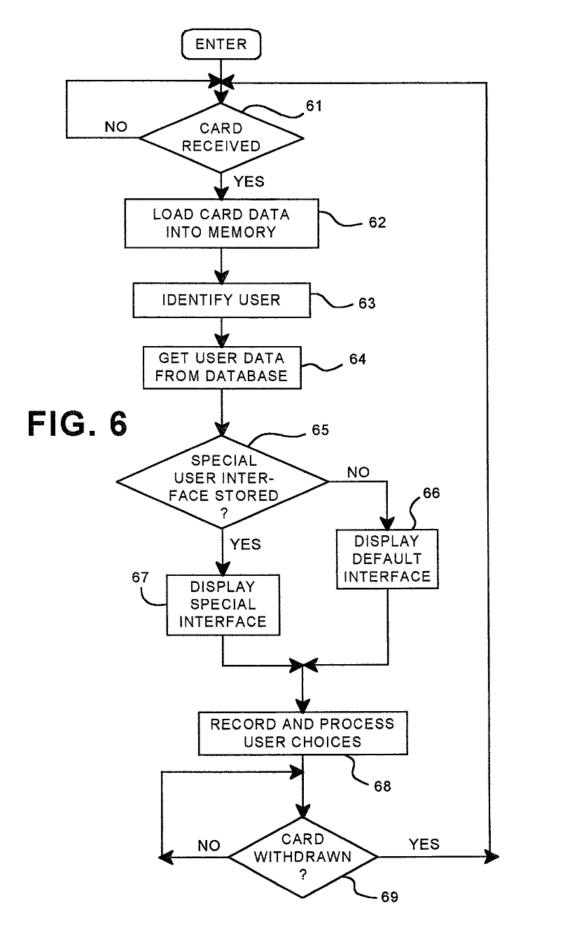

With this setup, the present invention will be subsequently described with respect to FIGS. 2 through 5. FIG. 2 shows a conventional menu screen 50 which may be displayed on an ATM machine when a user inserts a memory card without any stored personalization of the display screen. Thus, the menu 51 of banking options is normally presented and the selectable touch pads 52 are of normal size. Where there is personalization of the display, the data stored on the card may be used to format the display screen in the language of the user. Where the user has trouble reading text because of vision problems or because of physical problems such as Alzheimer's disease, then the display screen may be implemented in only symbols, as in FIG. 3 where symbols such as icon 53 asks the user to choose from symbolic menu 54 of banking functions on screen 50, which also has enlarged touch pads 52. For users with very limited vision, the menu screen of FIG. 2 may be rendered in a sequence of screens of enlarged text print 55, 56 of FIGS. 4 and 5 with enlarged touch pads 57.

The running of the process of this invention will be described with respect to the flowchart of FIG. 7. The flowchart represents some steps in a routine which will illustrate the operation of the invention as set forth above. An initial determination is made as to whether a card has been received, step 61. If No, the process is returned to step 61 where the insertion of a card is awaited. If Yes, a card has been inserted, then the card data is loaded into the system memory, step 62. The user is identified, step 63. Whatever user data is available is obtained from the system database, step 64, and stored together with whatever data comes from the card itself. A determination is then made as to whether the personalized data for the user indicates that a special interface is to be displayed, step 65. If No, then a default universal interface such as that of FIG. 2 is displayed, step 66. If Yes, then the special display interface is formed and displayed, step 67. After either step 66 or 67, the user's choices are sensed, recorded and processed, step 68. At this point, a determination may conveniently be made as to whether the card has been withdrawn, step 69. If Yes, then the process is returned to step 61 where the insertion of a new card is awaited. If No, then the process is returned to step 69 where the interactive user processing continues until the user card is withdrawn.

While this invention has been illustrated using a touch pad input, it will be clear to those skilled in the art that the invention is just as applicable with other input devices such as a computer mouse.

Although certain preferred embodiments have been shown and described, it will be understood that many changes and modifications may be made therein without departing from the scope and intent of the appended claims.

What is claimed is:

1. A computer controlled display terminal comprising:
means for receiving a withdrawable user card;
a withdrawable user card insertable into said receiving means including stored data specific to the user of said card; and
means responsive to said stored data for displaying on said terminal a layout of user interactive graphics personalized to said user.

2. The computer controlled display terminal of claim 1 wherein said display terminal includes a user interactive input touch screen having said layout of graphics personalized to said user.

3. The computer controlled display terminal of claim 2 wherein said layout of graphics includes a set of enlarged touch pads.

4. The computer controlled display terminal of claim 2 wherein said layout of graphics includes images personalized to said user.

5. The computer controlled display terminal of claim 2 wherein said user card includes integrated circuitry associated with said stored data.

6. The computer controlled display terminal of claim 5 wherein said user card is a smartcard.

7. The computer controlled display terminal of claim 2 wherein said display terminal is an automatic teller machine.

8. The computer controlled display terminal of claim 1 wherein said means responsive to said stored data also displays text personalized to said user.

9. The computer controlled display terminal of claim 8 wherein said text is in a language personalized to said user.

10. The computer controlled display terminal of claim 8 wherein said text is in an enlarged character font.

11. In a computer controlled display terminal adapted to receive a withdrawable user card, a method for personalizing the display user interface comprising:
inserting into said display terminal a user card including stored data specific to the user of said card; and
responsive to said stored data, displaying on said terminal display an interface layout of user interactive graphics personalized to said user.

12. The method of claim 11 wherein said display terminal includes a user interactive input touch screen having said layout of graphics personalized to said user.

13. The method of claim 12 wherein said layout of graphics is personalized to include a set of enlarged touch pads.

14. The method of claim 12 wherein said layout of graphics is personalized to include images personalized to said user.

15. The method of claim 11 wherein text personalized to said user is also displayed responsive to said stored data.

16. The method of claim 15 wherein said text is in a language personalized to said user.

17. The method of claim 15 wherein said text is in an enlarged character font personalized to the user's vision.

18. In a computer controlled display terminal adapted to receive a withdrawable user card, a program having code recorded on a computer readable medium for personalizing the display user interface comprising:
means for storing data specific to the user of said card; and
means responsive to said stored data for displaying on said terminal a layout of user interactive graphics personalized to said user.

19. The computer program of claim 18 wherein said display terminal includes a user interactive input touch screen having said layout of graphics personalized to said user.

20. The computer program of claim 19 wherein said layout of graphics includes a set of enlarged touch pads.

21. The computer program of claim 19 wherein said layout of graphics includes images personalized to said user.

22. The computer program of claim 19 wherein said user card includes integrated circuitry associated with said stored data.

23. The computer program of claim 22 wherein said user card is a smartcard.

24. The computer program of claim 19 wherein said display terminal is an automatic teller machine.

25. The computer program of claim 20 wherein said means responsive to said stored data also displays text personalized to said user.

26. The computer program of claim 25 wherein said text is in a language personalized to said user.

27. The computer program of claim 25 wherein said text is in an enlarged character font.
